(19) United States
(12) Patent Application Publication
(10) Pub. No.: US 2016/0209933 A1
(43) Pub. Date: Jul. 21, 2016

(54) METHOD AND DEVICE FOR ADJUSTING FUNCTION OF CONTROL BUTTON, AND SMART TERMINAL

(71) Applicants: HISENSE ELECTRIC CO., LTD., Shandong (CN); HISENSE USA CORPORATION, Suwanee, GA (US); HISENSE INTERNATIONAL CO., LTD., Shandong (CN)

(72) Inventors: Xuebin Sun, Shandong (CN); Fei Xue, Shandong (CN)

(21) Appl. No.: 14/794,912

(22) Filed: Jul. 9, 2015

(30) Foreign Application Priority Data
Jan. 15, 2015 (CN) 201510020794.2

(51) Int. Cl. G06F 3/023; G06F 3/02

(52) U.S. Cl. CPC G06F 3/0238; G06F 3/0227

(57) ABSTRACT

The present disclosure discloses a method and device for adjusting the function of a control button, and a smart terminal, the method generally including: detecting an operation event on the control button; and determining whether the smart terminal is positioned upside down, and if so, executing an operation instruction corresponding to a second function adjustment direction, opposite to a first function adjustment direction preset for the operation event.

### CROSS-REFERENCE TO RELATED APPLICATION

This application claims the benefit and priority of Chinese Patent Application No. 201510020794.2, filed Jan. 15, 2015. The entire disclosure of the above application is incorporated herein by reference.

### FIELD

The present disclosure relates to the field of communications and particularly to a method and device for adjusting the function of a control button, and a smart terminal.

### BACKGROUND

This section provides background information related to the present disclosure which is not necessarily prior art.

There are various types of existing smart terminals including convenient handheld smart terminals popular to a large number of users. The handheld smart terminals include handsets, tablet computers, portable android devices (PADs), etc.

In order to improve the effect of watching by a user, an existing handheld smart terminal, e.g., a PAD, etc., can have the orientation relationship between the user and the PAD adjusted as the user rotates the PAD by adjusting the orientation of a display picture (positioned upside up or upside down) so that the user can watch the adjusted display picture. As illustrated in FIG. 1A which is a schematic diagram of the user watching the display picture when the PAD is positioned upside up, the PAD at this time is positioned upside up so that the user watches it at an upside-up viewing angle, and the display picture is also positioned upside up for the viewing angle of the watching user; and as illustrated in FIG. 1B which is a schematic diagram of the user watching the display picture when the PAD is positioned upside down, the PAD at this time is positioned upside down so that the user watches it at an upside-down viewing angle relative to the PAD, and the display picture is also positioned upside down, relative to the PAD, in accordance with the viewing angle of the user.

Generally the volume control buttons “+” and “−” together with the other control buttons, arranged on the PAD, capable of bidirectional adjusting, are configured on the PAD at fixed hardware positions. For a PAD positioned upside up, as illustrated in FIG. 2, according to the usage habit of the user, the volume control button “+” is positioned on the upper part of the left edge or the right edge, so that the control button can be pressed to raise the volume, and the volume control button “−” is positioned below the volume control button “+” so that the control button can be pressed to lower the volume. As illustrated in FIG. 1A, the PAD is positioned upside up, and when the PAD is used by the user as if it were positioned upside up, even if the volume control buttons are not identified respectively as the volume control button “+” and the volume control button “−”, the upper volume control button “+” and the lower volume control button “−” can be determined, so that the user can operate properly to raise and lower the volume. However if the display picture can be rotated by rotating the PAD in orientation, then as illustrated in FIG. 1B, when the user adjusts the volume of the PAD as if it were positioned upside up, the upper volume control button “−” at this time may be mistaken for the volume control button “+”, thus resulting in a failure of the adjusting operation so as to degrade the experience of the user to some extent.

### SUMMARY

This section provides a general summary of the disclosure, and is not a comprehensive disclosure of its full scope or all of its features.

Embodiments of the disclosure provide a method and device for adjusting the function of a control button, and a smart terminal so as to address the problem in the prior art of a failure in operation when the control button of the smart terminal can not be adjusted.

One aspect relates to a method for adjusting the function of a control button, applicable to the control button capable of bidirectional adjusting, the method including:

detecting an operation event on the control button; and

determining whether the smart terminal is positioned upside down, and if so, executing an operation instruction corresponding to a second function adjustment direction, opposite to a first function adjustment direction preset for the operation event.

Another aspect relates to a device for adjusting the function of a control button in a smart terminal, applicable to the control button capable of bidirectional adjusting, the device including:

one or more processors,

a memory; and

wherein one or more computer readable program codes are stored in the memory, and the one or more processors are configured to execute the one or more computer readable program codes to perform:

detecting an operation event on the control button; and

determining whether the smart terminal is positioned upside down, and if so, executing an operation instruction corresponding to a second function adjustment direction, opposite to a first function adjustment direction preset for the operation event.

Yet another aspect relates to a smart terminal including the above device for adjusting the function of a control button.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1A illustrates a schematic diagram of the user watching the display picture when the PAD is positioned upside up;

FIG. 1B illustrates a schematic diagram of the user watching the display picture when the PAD is positioned upside down;

FIG. 2 illustrates a schematic diagram of the PAD when positioned upside up in a front view;

FIG. 3A, FIG. 3B and FIG. 3C illustrate three simplified schematic diagrams of control buttons according to embodiments of the disclosure;

FIG. 4 illustrates a flow chart of a method for adjusting the function of a control button according to an embodiment of the disclosure;

FIG. 5 illustrates schematic structural diagram of a device for adjusting the function of a control button according to an embodiment of the disclosure;

FIG. 6 illustrates schematic structural diagram of a smart terminal according to an embodiment of the disclosure; and

FIG. 7 illustrates schematic structural diagram of another smart terminal according to an embodiment of the disclosure.

### DETAILED DESCRIPTION

Example embodiments will now be described more fully with reference to the accompanying drawings. It shall be appreciated that the particular embodiments described here are merely intended to illustrate but not limit the disclosure.

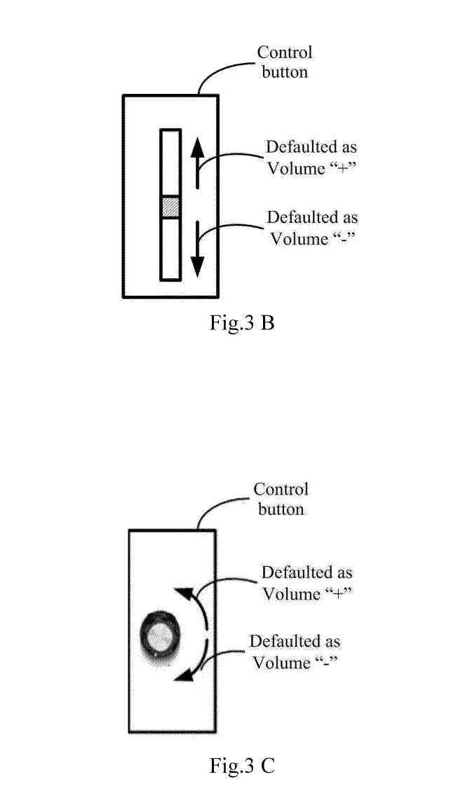

The embodiments of the disclosure relate to the method and device for adjusting the function of a control button, which are applicable to an existing smart terminal capable of rotating a display picture, although the disclosure will not be limited to any system to which the smart terminal is applicable. Moreover the smart terminal is arranged with at least one control button capable of bidirectional adjusting, which may be a set of buttons as illustrated in FIG. 3A or a button slide groove as illustrated in FIG. 3B or a knob as illustrated in FIG. 3C. Operations of clicking on the two buttons in the set of buttons correspond respectively to different adjustment directions. Alike two operations of sliding up and down in the button slide groove also correspond respectively to different adjustment directions, that is, sliding up and down can correspond respectively to a first function adjustment direction and a second function adjustment direction. Two operations of rotating the knob clockwise and counterclockwise at the same viewing angle correspond respectively to different adjustment directions, that is, rotation clockwise and counterclockwise can correspond respectively to a first function adjustment direction and a second function adjustment direction.

It shall be noted that the first function adjustment direction and the second function adjustment direction as referred to in the disclosure correspond respectively to bidirectional adjustment functions of the control button, for example, when the control button is a volume button, operation events corresponding thereto include an event of clicking on the button “+” and an event of clicking on the button “−”, where the event of clicking on the button “+” corresponds to the preset first function adjustment direction (to raise the volume), and the event of clicking on the button “−” corresponds to the preset second function adjustment direction (to lower the volume), or the event of clicking on the button “+” corresponds to the preset second function adjustment direction (to lower the volume), and the event of clicking on the button “−” corresponds to the preset first function adjustment direction (to raise the volume). Moreover the first function adjustment direction can be preset to lower the volume, and the second function adjustment direction can be preset to raise the volume.

Moreover in the embodiments of the disclosure, the smart terminal being positioned upside down refers to the smart terminal being positioned upside down relate to the viewing angle of the watching user, that is, the display picture of the smart terminal as seen by the user at this time is positioned upside down.

In the embodiments of the disclosure, an operation event on the control button is detected, and it is determined whether the smart terminal is positioned upside down, and if the smart terminal is positioned upside down, an operation instruction corresponding to a second function adjustment direction, opposite to a first function adjustment direction preset for the operation event, is executed, so that when the smart terminal is positioned upside down, if the user operates on any control button according to the usage habit when the smart terminal positioned upside down is used as if it were positioned upside up, then the smart terminal can adjust the function of the control button flexibly so that the user can adjust the control button in the smart terminal properly, as if it were positioned upside up, to thereby avoid an improper operation arising from mistaking the control button, and the flexible adjusting operation can improve the experience of the user to some extent.

The solution of the disclosure will be described below in details with reference to particular embodiments thereof, and the disclosure includes but will not be limited to the following embodiments.

FIG. 4 illustrates a flow chart of a method for adjusting the function of a control button according to an embodiment of the disclosure, where the method generally includes the following operations:

Operation 101: detecting an operation event on the control button.

In an embodiment of the disclosure, the operation event on the control button of the smart terminal in FIG. 3A, FIG. 3B and FIG. 3C can include but will not be limited to one of an event of clicking on the control button, an event of sliding the control button, and an event of rotating the control button.

Operation 102: determining whether the smart terminal is positioned upside down, and if so, executing an operation instruction corresponding to a second function adjustment direction, opposite to a first function adjustment direction preset for the operation event.

In an embodiment of the disclosure, whether the smart terminal is positioned upside down is determined by obtaining facial image information of the current user of the smart terminal; and determining from the facial image information whether the smart terminal is positioned upside down relative to the current user; or

Whether the smart terminal is positioned upside down is determined by determining from a sensing value of an acceleration sensor in the smart terminal whether the smart terminal is positioned upside down.

In an embodiment of the disclosure, the position orientation of the smart terminal can be determined in the following two approaches:

On one hand, facial image information of the current user is obtained, and position orientation information of the smart terminal relative to the current user is determined from the obtained facial image information; and

On the other hand, the current acceleration value of the smart terminal is sensed by an acceleration sensor configured in the smart terminal, and position orientation information of the smart terminal relative to the current user is determined from the acceleration value.

Here the facial image information of the current user of the smart terminal is obtained and it is determined from the facial image information whether the smart terminal is positioned upside down relative to the current user as follows:

A facial image of the current user is captured using a front camera of the smart terminal; and

The captured facial image is compared with a preset facial image, and it is determined from a result of the comparison whether the smart terminal is positioned upside down relative to the current user.

Here in an embodiment of the disclosure, the smart terminal is configured with at least one front camera so that when the smart terminal detects an operation event on the control button of the smart terminal, the front camera is triggered to capture facial image of the user in the current film range, where the facial image records partial or complete user facial information including at least information about the eyes of the user and the proximity thereof. Moreover at least one piece of preset facial image is stored in the smart terminal for a comparison check. The disclosure is generally directed to the smart terminal positioned upside down relative to the user, so the captured facial image information is compared with the preset facial image information generally by comparing the information about the eyes and the proximity thereof among the captured facial image with the information about the eyes and the proximity thereof among the preset facial image as a whole, it is determined whether a correspondence relationship between the information about the eyes and the proximity thereof among the captured facial image, and the smart terminal is structurally identical to a correspondence relationship between the information about the eyes and the proximity thereof among the preset facial image information, and the smart terminal, and if so, it is determined that the smart terminal is currently positioned upside up relative to the user; otherwise, it is determined that the smart terminal is currently positioned upside down relative to the user.

In an embodiment of the disclosure, the front camera can further capture facial image information of the current user in real time or periodically without taking the power consumption into account in addition to capturing facial image information of the current user when an operation event on the control button of the smart terminal is detected.

In an embodiment of the disclosure, when there are a plurality of users in the film range of the front camera, after the facial image information of the current user is captured, the method further includes:

The user with the highest priority is identified from preset user information, and facial image of the user with the highest priority is cut out.

Here when there are a plurality of users in the film range of the front camera, there are a number of facial images in the film range, and in order to highlight the prominent user and to ensure rapid operations, after the facial images of the current users are captured, the user with the highest priority is identified from the preset user information, and facial image of the user with the highest priority is cut out. For example, user information of frequently accessing users can be stored in advance in the smart terminal, so the number of times of being used can be taken as a priority parameter; and moreover the distance of the users from the smart terminal can also be taken as a priority parameter so that there are a higher priority at a shorter distance and a lower priority at a longer distance.

The captured facial image information is compared with the preset facial image information and it is determined whether the smart terminal is currently positioned upside down relative to the user particularly as follows:

The facial image of the user with the highest priority is compared with the preset facial image, and if they are identical, then an upper side-up viewing angle of the current watching user relative to the smart terminal is determined; otherwise, an upper side-down viewing angle of the current watching user relative to the smart terminal is determined.

In an embodiment of the disclosure, an operation instruction corresponding to the first function adjustment direction is executed when it is determined that the smart terminal is positioned upside up.

The solution above to adjusting of the function of a control button will be described below in further details by way of particular examples.

Taking the control button illustrated in FIG. 3A as an example, the control button is assumed to represent a volume button. When the smart terminal is positioned upside up, the volume button “+” is positioned upper, and the volume button “−” is positioned lower (or the volume button “−” is positioned upper, and the volume button “+” is positioned lower). Here regardless of the position of the smart terminal relative to the user, when the volume button “+” is pressed, it is determined that the first function adjustment direction preset for the operation event is raising the volume, and then the operation instruction to raise the volume is executed; and when the volume button “−” is pressed, it is determined that the second function adjustment direction preset for the operation event is lowering the volume, and then the operation instruction to lower the volume is executed, thus adjusting the volume.

In order to avoid problem of a failure of the adjusting operation arising from mistaking the control button by the user using the smart terminal positioned upside down as if it were positioned upside up, the position of the smart terminal relative to the user (positioned upside down or up) has been taken into full account in the examples of the disclosure.

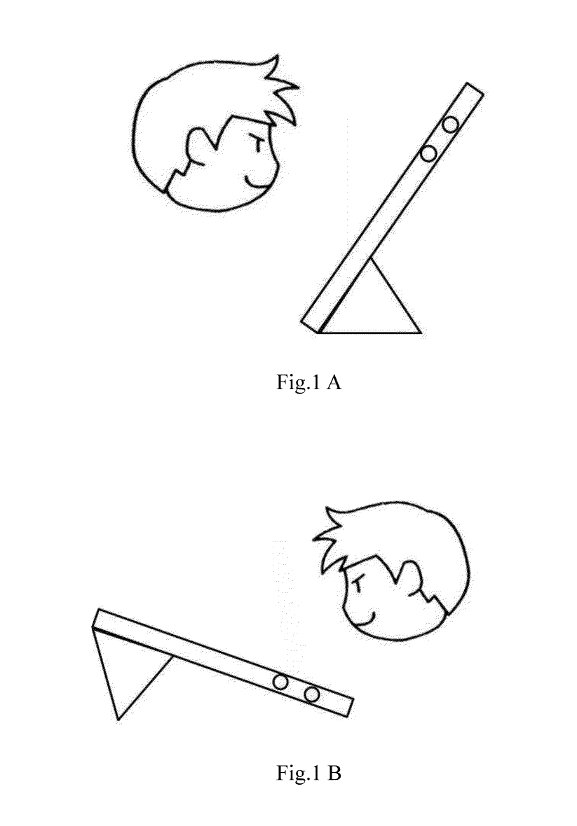

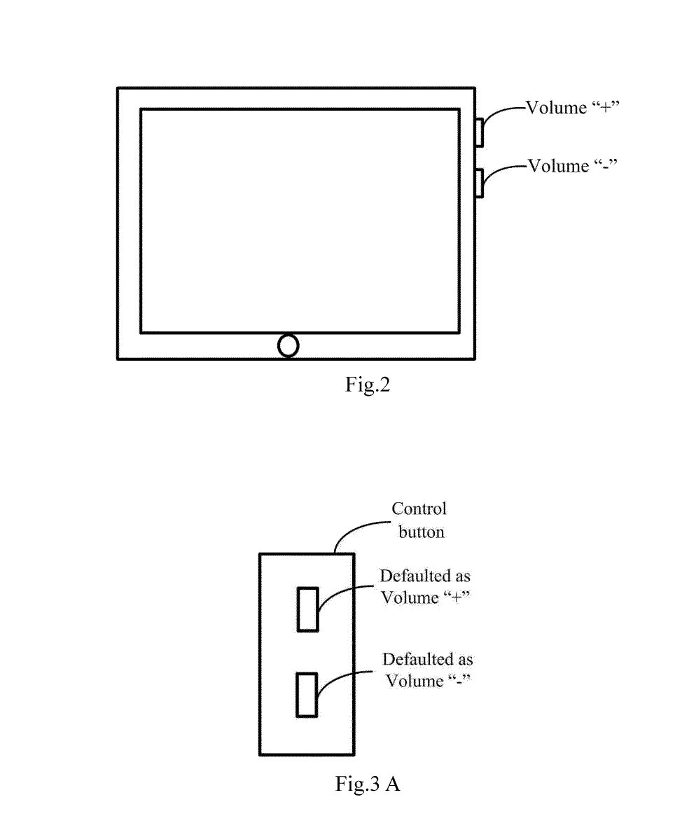

For example, the user currently watches the display picture in the PAD as illustrated in FIG. 1B.

When the user determines that the current volume is not high enough and needs to be raised, the user will click on the upper volume control button positioned on the PAD (being positioned upside down) at this time as if the PAD were positioned upside up, and it shall be noted that the volume control button being pressed is actually the volume button “−”, so the effect of lowering the volume shall be achieved as a result in the prior art.

However when the PAD capable of adjusting the function of a control button in the disclosure detects an event of clicking on the control button by the user, firstly the PAD obtains the current position direction of the smart terminal relative to the user, acquires facial image information of the current user using the front camera, and determines the position direction of the smart terminal relative to the user to be positioned upside down as described in the disclosure for processing the facial image or as done in the prior art for processing the facial image.

Thereafter it is determined that the smart terminal is positioned upside down relative to the user, so the smart terminal will not execute the operation instruction corresponding to the clicking on the volume button “−” but execute the operation instruction corresponding to the clicking on the volume button “+” to thereby raise the volume. This technical solution can adjust the volume as desirable to the user, lower the failure ratio of the adjusting operation, and improve the experience of the user to some extent.

Based upon the same inventive idea as the method for adjusting the function of a control button according to an embodiment of the disclosure, an embodiment of the disclosure further provides a device for adjusting the function of a control button.

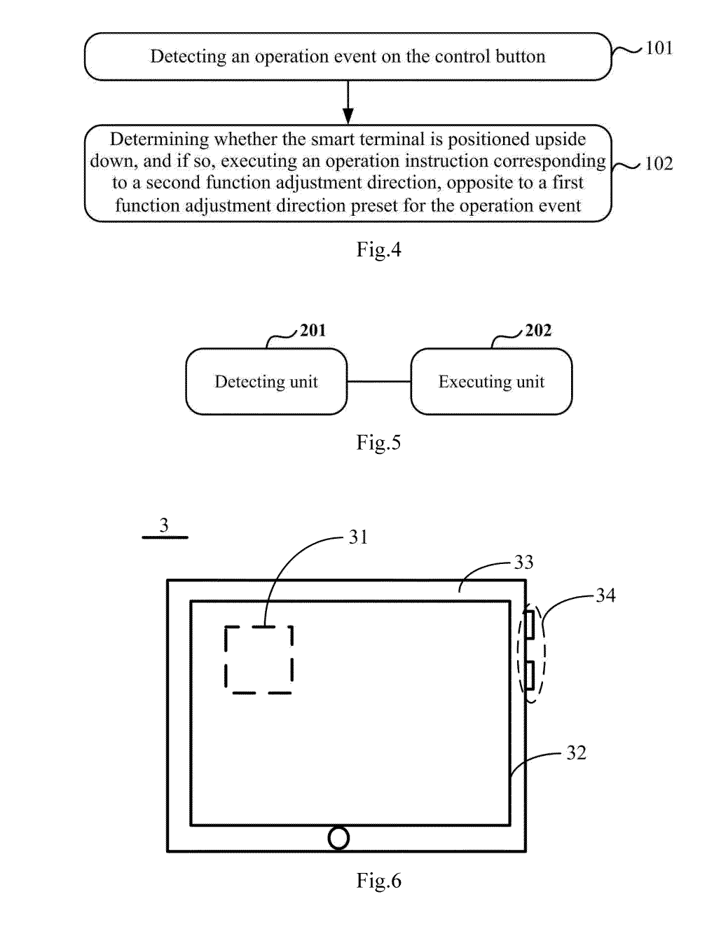

FIG. 5 illustrates schematic structural diagram of a device for adjusting the function of a control button according to an embodiment of the disclosure, where the device is generally integrated in a smart terminal and can be a chip capable of processing data or can be a processor. The device generally includes:

One or more processors,

A memory; and

wherein one or more computer readable program codes are stored in the memory, and the one or more processors are configured to perform the one or more computer readable program codes to perform the functions of:

A detecting unit 201 configured to determine detect an operation event on the control button; and

An executing unit 202 is configured to determine whether the smart terminal is positioned upside down, and if so, to execute an operation instruction corresponding to a second function adjustment direction, opposite to a first function adjustment direction preset for the operation event.

Here the operation event as referred to in the disclosure includes one of:

An event of clicking on the control button, an event of sliding the control button, or an event of rotating the control button.

It shall be noted that the detecting unit 201 as referred to in the embodiment of the disclosure can be a function module connected with a front camera through an internal channel.

In an embodiment of the disclosure, the one or more processors are further configured to execute the one or more computer readable program codes to perform the functions of:

A determining unit configured to obtain facial image information of the current user of the smart terminal and to determine from the obtained facial image information whether the smart terminal is positioned upside down relative to the current user; or

To determine from a sensing value of an acceleration sensor in the smart terminal whether the smart terminal is positioned upside down.

In an embodiment of the disclosure, the determining unit is configured:

To capture a facial image of the current user using a front camera of the smart terminal; and

To compare the captured facial image with a preset facial image and to determine from a result of the comparison whether the smart terminal is positioned upside down relative to the current user.

In an embodiment of the disclosure, the determining unit is further configured:

After the facial image of the current user is obtained, to identify from preset user information a user with the highest priority and to cut out facial image of the user with the highest priority; and

To compare the facial image of the user with the highest priority with the preset facial image, and if they are identical, to determine the smart terminal to be positioned upside up relative to the current user; otherwise, to determine the smart terminal to be positioned upside down relative to the current user.

In an embodiment of the disclosure, the executing unit 202 is further configured to execute an operation instruction corresponding to the first function adjustment direction when it is determined that the smart terminal is positioned upside up relative to the current user.

Moreover the disclosure provides a smart terminal, as illustrated in FIG. 6, including the device 31 above for adjusting the function of a control button, where the dotted box represents the integration of the device in the smart terminal, and also including an existing display screen 32 and display module 33, and the at least one control button 34 as referred to in the embodiments above.

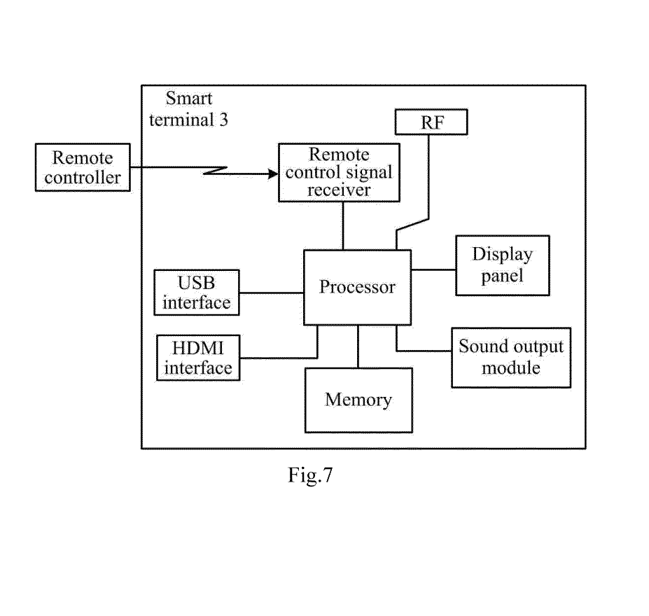

Particularly as illustrated in FIG. 7, the smart terminal 3 can include a memory, an input unit, an output unit, one ore more processors and other components. Those skilled in the art can appreciate that the smart terminal 3 will not be limited to the structure as illustrated in FIG. 7 but can include more or less components than those as illustrated or some components which are combined or some components which are arranged otherwise, where:

The memory can be configured to store software programs and modules, and the processor can run the software programs and the modules stored in the memory to perform respective functional applications and data processing. The memory can include a high-speed random access memory and can also include a nonvolatile memory, e.g., at least one magnetic disk memory, flash memory or another volatile solid-state memory. Moreover the memory can also include a memory controller to provide the processor and an input unit with an access to the memory; and

The processor is a control center of the smart terminal 3, and connects the respective components throughout the smart terminal through various interfaces and lines, so that the processor runs or executes the software programs and/or the modules stored in the memory and invokes the data stored in the memory to perform the respective functions of the smart terminal and to process the data so as to supervise the smart terminal as a whole. Alternatively the processor can include one or more processing cores; and alternatively the processor can be integrated with an application processor and a modem processor, where the application processor generally handles an operating system, user interfaces, applications, etc., and the modem processor generally handles wireless communication. As can be appreciated, the modem processor above may not be integrated into the processor.

The smart terminal 3 can further include a TV and radio receiver, a high-definition multimedia interface, a USB interface, an audio and video input component and other input units, and the input unit can further include a remote control receiver to receive a signal transmitted by a remote controller. Moreover the input unit can further include a touch sensitive surface and another input device, where the touch sensitive surface can be embodied in various types of resistive, capacitive, infrared, surface sound wave and other types, and the other input device can include but will not be limited to one or more of a physical keyboard, functional keys (e.g., a power-on or power-off press key, etc.), a track ball, a mouse, a joystick, etc.

The output unit is configured to output an audio signal, a video signal, an alert signal, a vibration signal, etc. The output unit can include a display panel, a sound output module, etc. The display panel can be configured to display information input by the user or information provided to the user and various graphic user interfaces of the smart terminal 3, where these graphic user interfaces can be composed of graphics, texts, icons, videos and any combination thereof. For example, the display panel can be embodied as a Liquid Crystal Display (LCD), an Organic Light-Emitting Diode (OLED), a flexible display, a 3D display, a Cathode Ray Tube (CRT), a plasmas display panel, etc.

The smart terminal 3 can further include at least one sensor (not illustrated), e.g., an optical sensor, a motion sensor and other sensors. Particularly the optical sensor can include an ambient light sensor and a proximity sensor, where the ambient light sensor can adjust the brightness of the display panel according to the luminosity of ambient light rays, and the proximity sensor can power off the display panel and/or backlight when the smart terminal 3 moves to certain location. The smart terminal 3 can be further configured with a gyroscope, a barometer, a hygrometer, a thermometer, an infrared sensor and other sensors.

The smart terminal 3 can further include an audio circuit (not illustrated), a speaker and a microphone in which can provide an audio interface between the user and the smart terminal 3. The audio circuit can convert received audio data into an electric signal and transmit the electric signal to the speaker, which is converted by the speaker into an audio signal for output; and on the other hand, the microphone converts a collected audio signal into an electric signal which is received by the audio circuit and then converted into audio data, and the audio data is further output to the processor for processing and then transmitted to another display device, for example, or the audio data is output to the memory for further processing. The audio circuit may further include an earphone jack for communication between a peripheral earphone and the smart terminal 3.

Moreover the smart terminal 3 can further include a Radio Frequency (RF) circuit. The RF circuit can be configured to receive and transmit a signal. Typically the RF circuit includes but will not be limited to an antenna, at least one amplifier, a tuner, one or more oscillators, a Subscriber Identifier Module (SIM) card, a transceiver, a coupler, a Low Noise Amplifier (LNA), a duplexer, etc. Moreover the smart terminal 3 can further include a web cam, a Bluetooth module, etc.

Moreover the smart terminal 3 can further include a Wireless Fidelity (WiFi) module (not illustrated). The WiFi technology falls into the category of short-range wireless transmission technologies, and the smart terminal 3 can assist the user in receiving and transmitting an e-mail, browsing a webpage, accessing streaming media, etc., through the WiFi module by which the user is provided with a wireless access to the broadband Internet. Although the WiFi module is illustrated in FIG. 7, it can be appreciated that it may not be necessarily required for the smart terminal 3 but can be omitted as desired without departing from the scope of the disclosure.

Those skilled in the art shall appreciate that the embodiments of the disclosure can be embodied as a method, a system or a computer program product. Therefore the disclosure can be embodied in the form of an all-hardware embodiment, an all-software embodiment or an embodiment of software and hardware in combination. Furthermore the disclosure can be embodied in the form of a computer program product embodied in one or more computer useable storage mediums (including but not limited to a disk memory, a CD-ROM, an optical memory, etc.) in which computer useable program codes are contained.

The disclosure has been described in a flow chart and/or a block diagram of the method, the device (system) and the computer program product according to the embodiments of the disclosure. It shall be appreciated that respective flows and/or blocks in the flow chart and/or the block diagram and combinations of the flows and/or the blocks in the flow chart and/or the block diagram can be embodied in computer program instructions. These computer program instructions can be loaded onto a general-purpose computer, a specific-purpose computer, an embedded processor or a processor of another programmable data processing device to produce a machine so that the instructions executed on the computer or the processor of the other programmable data processing device create means for performing the functions specified in the flow(s) of the flow chart and/or the block(s) of the block diagram.

These computer program instructions can also be stored into a computer readable memory capable of directing the computer or the other programmable data processing device to operate in a specific manner so that the instructions stored in the computer readable memory create an article of manufacture including instruction means which perform the functions specified in the flow(s) of the flow chart and/or the block(s) of the block diagram.

These computer program instructions can also be loaded onto the computer or the other programmable data processing device so that a series of operational steps are performed on the computer or the other programmable data processing device to create a computer implemented process so that the instructions executed on the computer or the other programmable device provide steps for performing the functions specified in the flow(s) of the flow chart and/or the block(s) of the block diagram.

Although the embodiments of the disclosure have been described, those skilled in the art benefiting from the underlying inventive concept can make additional modifications and variations to these embodiments. Therefore the appended claims are intended to be construed as encompassing the embodiments and all the modifications and variations coming into the scope of the disclosure.

Evidently those skilled in the art can make various modifications and variations to the disclosure without departing from the spirit and scope of the disclosure. Thus the disclosure is also intended to encompass these modifications and variations thereto so long as the modifications and variations come into the scope of the claims appended to the disclosure and their equivalents.

1. A method for adjusting function of a control button, applicable to the control button capable of bidirectional adjusting in a smart terminal, the method comprising:
detecting an operation event on the control button; and
determining whether the smart terminal is positioned upside down, and if so, executing an operation instruction corresponding to a second function adjustment direction, opposite to a first function adjustment direction preset for the operation event.

2. The method according to claim 1, wherein the operation event comprises one of:
an event of clicking on the control button, an event of sliding the control button, or an event of rotating the control button.

3. The method according to claim 1, wherein determining whether the smart terminal is positioned upside down comprises:
obtaining facial image information of a current user of the smart terminal, and determining from the facial image information whether the smart terminal is positioned upside down relative to the current user; or
determining from a sensing value of an acceleration sensor in the smart terminal whether the smart terminal is positioned upside down.

4. The method according to claim 3, wherein obtaining the facial image information of the current user of the smart terminal, and determining from the facial image information whether the smart terminal is positioned upside down relative to the current user comprises:
capturing the facial image information of the current user using a front camera of the smart terminal; and
comparing the captured facial image information with preset facial image information, and determining from a result of the comparison whether the smart terminal is positioned upside down relative to the current user.

5. The method according to claim 4, wherein when there are a plurality of user in a film range of the front camera, after the facial image information of the current user is captured, the method further comprises:
identifying from preset user information a user with a highest priority, and cutting out a facial image of the user with the highest priority; and
comparing the captured facial image information with the preset facial image information, and determining from the result of the comparison whether the smart terminal is positioned upside down relative to the current user comprises:
comparing the facial image of the user with the highest priority with the preset facial image, and if they are identical, then determining the smart terminal to be positioned upside up relative to the current user; otherwise, determining the smart terminal to be positioned upside down relative to the current user.

6. The method according to claim 1, wherein an operation instruction corresponding to the first function adjustment direction is executed when it is determined that the smart terminal is positioned upside up relative to the current user.

7. A device for adjusting function of a control button, applicable to the control button capable of bidirectional adjusting in a smart terminal, the device comprising:
one or more processors,
a memory; and
wherein one or more computer readable program codes are stored in the memory, and the one or more processors are configured to execute the one or more computer readable program codes to perform:
detecting an operation event on the control button; and
determining whether the smart terminal is positioned upside down, and if so, executing an operation instruction corresponding to a second function adjustment direction, opposite to a first function adjustment direction preset for the operation event.

8. The device according to claim 7, wherein the operation event comprises one of:
an event of clicking on the control button, an event of sliding the control button, or an event of rotating the control button.

9. The device according to claim 7, wherein the one or more processors are further configured to execute the one or more computer readable program codes to perform:
obtaining facial image information of a current user of the smart terminal, and determining from the facial image information whether the smart terminal is positioned upside down relative to the current user; or
determining from a sensing value of an acceleration sensor in the smart terminal whether the smart terminal is positioned upside down.

10. The device according to claim 9, wherein the one or more processors are further configured to execute the one or more computer readable program codes to perform:
capturing the facial image information of the current user using a front camera of the smart terminal; and
comparing the captured facial image information with preset facial image information, and determining from a result of the comparison whether the smart terminal is positioned upside down relative to the current user.

11. The device according to claim 10, wherein the one or more processors are further configured to execute the one or more computer readable program codes to perform:
after the facial image information of the current user is captured, identifying from preset user information a user with a highest priority, and cutting out a facial image of the user with the highest priority; and
comparing the facial image of the user with the highest priority with the preset facial image, and if they are identical, then determining the smart terminal to be positioned upside up relative to the current user; otherwise, determining the smart terminal to be positioned upside down relative to the current user.

12. The device according to claim 7, wherein the one or more processors are further configured to execute the one or more computer readable program codes to perform:
executing an operation instruction corresponding to the first function adjustment direction when it is determined that the smart terminal is positioned upside up relative to the current user.

13. A smart terminal, comprising a device for adjusting function of a control button, applicable to the control button capable of bidirectional adjusting in the smart terminal, the device comprising:
one or more processors,
a memory; and
wherein one or more computer readable program codes are stored in the memory, and the one or more processors are configured to execute the one or more computer readable program codes to perform:
detecting an operation event on the control button; and
determining whether the smart terminal is positioned upside down, and if so, executing an operation instruction corresponding to a second function adjustment direction, opposite to a first function adjustment direction preset for the operation event.
